(19) United States
(12) Patent Application Publication
(10) Pub. No.: US 2012/0010047 A1
(43) Pub. Date: Jan. 12, 2012

(54) METHOD AND DEVICE FOR CONTROLLING THE CLUTCH IN COASTING OPERATION OF A MOTOR VEHICLE

(76) Inventors: Stefan STRENGERT, Stuttgart (DE); Michael Kunz, Steinheim An Der Murr (DE)

(21) Appl. No.: 13/166,457

(22) Filed: Jun. 22, 2011

(30) Foreign Application Priority Data
Jul. 7, 2010 (DE) 102010031036.0

(51) Int. Cl. B60W 10/02; B60W 30/18

(52) U.S. Cl. 477/171; 477/174

(57) ABSTRACT

A method and a device for operating a motor vehicle, in which during driving mode
the frictional connection between the vehicle engine and at least one drive axle is interrupted, and
the vehicle engine is shut down,
   wherein the frictional connection between the vehicle engine and the at least one drive axle is restored when the driver operates an operating element, the vehicle engine remaining in the off state.

### BACKGROUND INFORMATION

German Patent No. DE 102 21 701 describes a method for controlling a motor vehicle in coasting operation. In this method the clutch is disengaged, while the gear is engaged, by an electronic control unit in a controlled manner, and the engine is shut down, if necessary, so that the vehicle rolls without losing kinetic energy due to the braking action of the engine. The coasting mode is usually terminated by operating a brake and/or the gas pedal.

### SUMMARY OF THE INVENTION

The present invention relates to a method for operating a motor vehicle, in which during driving operation

the frictional connection between the vehicle engine and at least one drive axle is interrupted and

the vehicle engine is turned off.

Such an operating state of the vehicle is also referred to as “coasting” or “coasting mode.”

The core of the present invention is that when the driver operates an operating element, the frictional connection between the vehicle engine and the at least one drive axle is restored while the vehicle engine remains in the off state. For example, the vehicle engine may now drive systems such as a generator or a vacuum pump due to the frictional connection which is now available. The term “driving mode” here means that the vehicle is in a driving state having a vehicle speed different from zero. It is of course also possible to restore the frictional connection between the vehicle engine and all the drive axles.

One advantageous embodiment of the present invention is characterized in that the operating element is a brake operating element, in particular the brake operating element is the brake pedal. This makes it possible to include the vehicle engine in a braking operation without consuming fuel. For the case when the vehicle has a vacuum brake booster having a vacuum pump driven by the vehicle engine, in this case the vacuum pump is driven and the vacuum is maintained in the brake booster. This prevents a gradual decline in the vacuum in the event of braking and thus ensures the availability of the full braking power at any time.

One advantageous embodiment of the present invention is characterized in that, when the brake operating element is operated, the frictional connection between the vehicle engine and the at least one drive axle is restored only when the vacuum in the brake booster additionally drops below a predefined intensity. Restoration of the frictional connection and, associated with that, comfort-reducing jerking movements of the vehicle are therefore prevented when the vacuum is still strong enough. The vacuum in the brake booster then drops below a predefined vacuum intensity level when the pressure, which is given in bar, for example, exceeds a threshold value. In the case of a pressure level of 0.1 bar, this is a greater vacuum than that at a pressure level of 0.2 bar. There is no longer a vacuum at a pressure of 1 bar.

One advantageous embodiment of the present invention is characterized in that at least one valve of the internal combustion engine is opened in addition to restoring the frictional connection. The jerking movements of the vehicle when closing the frictional connection are therefore further minimized.

One advantageous embodiment of the present invention is characterized in that the frictional connection is interrupted again after the end of the operation of the operating element. In particular a restored frictional connection between the vehicle engine and the at least one drive axle is terminated when the vacuum in the brake booster exceeds a predefined intensity level, i.e., when the vacuum is strong enough again. In this case, the full availability of the brake force is ensured and the vacuum pump of the brake booster need not be driven further.

One advantageous embodiment of the present invention is characterized in that the frictional connection is established or restored by engaging a clutch and is interrupted by disengaging the clutch.

One advantageous embodiment of the method is characterized in that the frictional connection between the vehicle engine and the at least one drive axle is restored by operating the accelerator pedal, and the vehicle engine is started again.

The present invention further relates to a device containing means designed for implementing the method according to the present invention.

### BRIEF DESCRIPTION OF THE DRAWINGS

FIG. 1 shows the sequence of one specific embodiment of the method according to the present invention.

FIG. 2 shows the structure of the device according to the present invention.

### DETAILED DESCRIPTION

One possible strategy for saving fuel in a motor vehicle is so-called “coasting,” which may be used in vehicles driven by an internal combustion engine as well as with hybrid vehicles. In coasting, the internal combustion engine is shut down and the transmission is disengaged if the instantaneous driving situation allows that. For example, during a drive with minimal deceleration and non-operated accelerator pedal, the vehicle may be switched to coasting independently of the driver. The drag on the vehicle is therefore minimized and the vehicle “coasts” without consuming fuel.

Most vehicles today have a vacuum booster for brake power boosting. The vacuum required for this is generated by the internal combustion engine in most cases. The required vacuum is often generated by a mechanical vacuum pump flanged directly to the internal combustion engine.

During braking of the vehicle, the vacuum is “used up,” i.e., the vacuum level in the brake booster drops. However, this lack of vacuum cannot be counteracted in coasting mode because the internal combustion engine is shut down and thus the mechanically driven vacuum pump no longer evacuates the vacuum booster. In particular through repeated braking within the coasting mode, the vacuum level or the vacuum intensity in the brake booster may drop to such an extent that there is only inadequate brake power boosting or none at all.

A basic idea of the present invention is that the clutch is automatically engaged in the case when the driver's wish to decelerate is detected during coasting mode. The internal combustion engine is therefore driven and the mechanical vacuum pump is also driven and evacuates the brake booster during braking. Thus in general the same vacuum level as before prevails again in the vacuum booster. It is possible in this way to avoid starting the internal combustion engine and no fuel is consumed.

Since the driver would like to brake anyway, the additional braking torque due to the engagement of the clutch is not unwanted. Annoying jerkiness may be avoided by smooth regulation of the clutch, in particular a regulated clutch-engaging operation. A further reduction in jerkiness may be achieved with modern engines by opening the valves with the aid of variable valve control. There is no compression in the internal combustion engine due to the opened valves, for example, the outlet valves. Since no compression work need be performed, the internal combustion engine may be driven at very low torques. Therefore any jerking is further minimized.

It is of course also possible to apply the method described above only beyond a certain vacuum level. In coasting mode with a sufficiently high vacuum, braking is accomplished from the vacuum stored in the vacuum booster but the clutch initially remains disengaged. Only when a defined pressure level is exceeded, i.e., the vacuum drops too low, is the clutch engaged again and the method described above performed. For example, this may take place after the third braking within the coasting mode. The clutch is preserved by this method because clutch engagement operations are minimized. In addition, any comfort requirements are easier to meet because there need not be any clutch engagement during braking.

The methods according to the present invention are suitable for vehicles having an internal combustion engine and a mechanically driven vacuum pump. However, it is also conceivable to use this method in vehicles having an intake manifold vacuum. In the case of force-operated valves, the vacuum booster is also evacuated during coasting in unfired coasting mode. The present invention is also applicable to hybrid vehicles which may be driven electrically for a distance, and this may also be applied during the distances which are driven electrically.

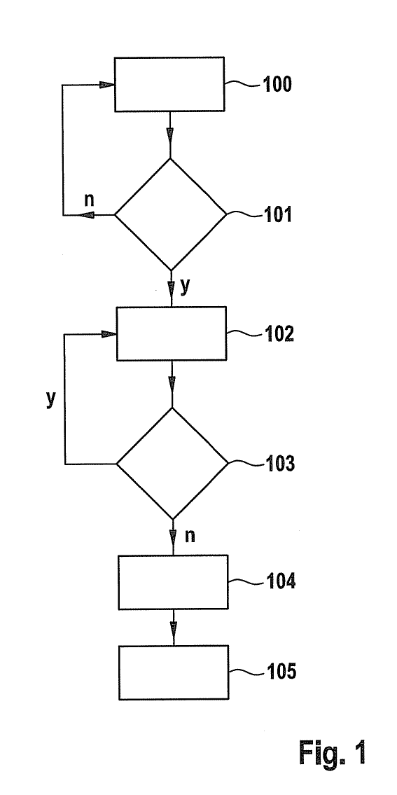

FIG. 1 illustrates the sequence of one specific embodiment of the method according to the present invention. The method proceeds when the vehicle is in driving mode with an interrupted frictional connection between the vehicle engine and at least one drive axle and with the engine shut down. After the start of the method in block 100, the operation of an operating element by the driver is queried in block 101; this element may be the brake pedal in particular. If there is no brake pedal operation, the system branches back to block 100. However, if the brake pedal has been operated, then in block 102 in a simple specific embodiment, the frictional connection between the vehicle engine and at least one drive axle is restored. In another specific embodiment, the frictional connection is restored in block 102 only if at the same time the pressure level in the brake booster drops below a predefined level, i.e., in other words, when the vacuum becomes too weak. In block 103, there is then a query as to whether the operating element is still being operated. If this is the case, then it branches back to block 102. However, if the operating element is no longer being operated, then in block 104 the frictional connection between the vehicle engine and at least one drive axle is interrupted again. In an alternative specific embodiment, the frictional connection may also be interrupted when the pressure level in the brake booster exceeds a predefined value, i.e., is strong enough again. The method ends in block 105.

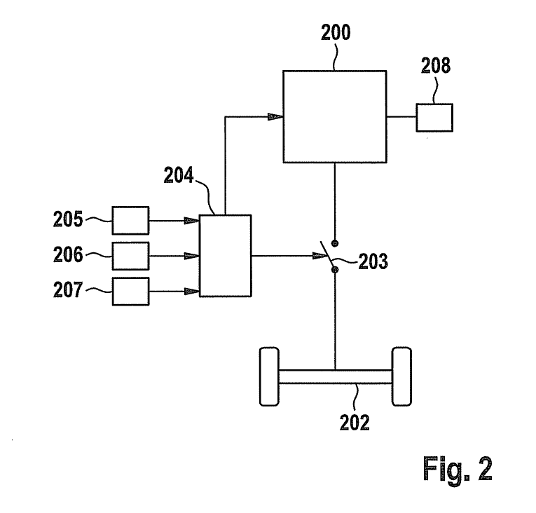

FIG. 2 shows the structure of the device according to the present invention, where reference numeral 200 denotes the vehicle engine and reference numeral 202 denotes a drive axle. Of course reference numeral 202 may also include multiple drive axles, in particular all the drive axles. Reference numeral 203 denotes an operating element or a device for establishing a mechanical frictional connection between 200 and 202, 203 possibly being a clutch in particular. A control unit 204 triggers 203 and then in turn receives input signals from brake pedal 205, accelerator pedal 206 and clutch pedal 207, for example. Reference numeral 208 denotes the vacuum pump of the vacuum brake booster which is driven by engine 200.

What is claimed is:

1. A method for operating a motor vehicle, during driving mode, the method comprising:
interrupting a frictional connection between a vehicle engine and at least one drive axle;
shutting down the vehicle engine; and
restoring the frictional connection between the vehicle engine and the at least one drive axle when a driver operates an operating element, the vehicle engine remaining in an off state.

2. The method according to claim 1, wherein the operating element is a brake operating element.

3. The method according to claim 2, wherein the brake operating element is a brake pedal.

4. The method according to claim 2, wherein:
the vehicle has a vacuum brake booster having a vacuum pump driven by the vehicle engine, and
when the brake operating element is operated, the frictional connection between the vehicle engine and the at least one drive axle is then restored only if the vacuum in the brake booster has additionally fallen below a predefined intensity.

5. The method according to claim 1, wherein at least one valve of the internal combustion engine is opened in addition to restoring the frictional connection.

6. The method according to claim 1, wherein the frictional connection is interrupted again after an operation of an operating element is terminated.

7. The method according to claim 4, wherein a restored frictional connection between the vehicle engine and the at least one drive axle is terminated when the vacuum in the brake booster exceeds a predefined intensity.

8. The method according to claim 1, wherein the frictional connection is restored by engaging a clutch and is interrupted by disengaging the clutch.

9. The method according to claim 3, wherein the frictional connection between the vehicle engine and the at least one drive axle is restored by operating an accelerator pedal and the vehicle engine is started again.

10. A device for operating a motor vehicle, during driving mode, the device comprising:
means for interrupting a frictional connection between a vehicle engine and at least one drive axle;
means for shutting down the vehicle engine; and
means for restoring the frictional connection between the vehicle engine and the at least one drive axle when a driver operates an operating element, the vehicle engine remaining in an off state.
